(19) United States
(12) Patent Application Publication
(10) Pub. No.: US 2017/0051774 A1
(43) Pub. Date: Feb. 23, 2017

(54) Blind Rivet Element

(71) Applicant: PROFIL Verbindungstechnik GMBH & Co. KG, Friedrichsdorf (DE)

(72) Inventors: Oliver Diehl, Usingen (DE); Andreas Lembach, Darmstadt (DE)

(21) Appl. No.: 15/239,407

(22) Filed: Aug. 17, 2016

(30) Foreign Application Priority Data
Aug. 18, 2015 (DE) 102015113676.7

(51) Int. Cl. F16B 19/10; B21J 15/04; F16B 37/00

(52) U.S. Cl. CPC F16B 19/1054; F16B 37/00; B21J 15/043

(57) ABSTRACT

A blind rivet element for fastening to a workpiece which has a hole, which is in particular preshaped, comprises a sleeve body and a bolt element led through the sleeve body, wherein the blind rivet element can be introduced into the hole of the workpiece and the sleeve body can be sectionally deformed by an axial movement of the bolt element relative to the sleeve body to fasten the blind rivet element to the workpiece. The sleeve body has at least one contact section which is arranged and configured such that the contact section cuts into a wall of the hole and/or into a region around the hole and/or effects a deformation of the wall of the hole and/or of the region around the hole, in particular to establish an electrical contract between the workpiece and the blind rivet element.

The present invention relates to a blind rivet element for fastening to a workpiece, wherein the blind rivet element comprises a sleeve body and a bolt element led through the sleeve body. The blind rivet element is typically first introduced into a hole of the workpiece. The sleeve body is then sectionally deformed by an axial movement of the bolt element relative to the sleeve body to fasten the blind rivet element to the workpiece.

Such a blind rivet element is also known as a pull mandrel rivet and is frequently used when a stable and permanent connection should be established with a workpiece which is only accessible from the outside, i.e. from one side, e.g. a closed hollow body.

In an exemplary application, a blind rivet element is fastened to a fuel tank to provide a ground connection, i.e. a connection for an electrical grounding of the fuel tank. There is a challenge in this respect also to establish a reliable electrical connection between the blind rivet element and the fuel tank, in addition to a stable and permanent fastening of the blind rivet element which serves as a mechanical connection point for a ground wire, so that the fuel tank is actually grounded when the ground wire is connected. A reliable electrical grounding is actually particularly important with fuel tanks since electrostatic charges on the surface of the fuel tank can result in spark-rich discharge processes which could ignite a fuel mixture located in the fuel tank and could lead to an explosion of the fuel tank.

An electrical connection between the workpiece and the blind rivet element serving as a ground connection is, however, not directly ensured when a conventional blind rivet element is fastened to the workpiece in a manner known per se, and indeed not even if both the workpiece and the blind rivet element are formed from electrically conductive metal at least in the region of their cooperation. There is a problem in that the workpiece in particular frequently has a protective coat which has no or only comparatively poor electrical conductivity and which therefore prevents an effective electrical connection between the workpiece and the blind rivet element.

It is therefore an object of the invention to provide a blind rivet element of the initially named kind which ensures a reliable mechanical and/or electrical connection between a workpiece and the blind rivet element when the blind rivet element is fastened to the workpiece.

This object is satisfied by a blind rivet element having the features of claim 1 and in particular in that the sleeve body has at least one contact section which is arranged and configured such that the contact section cuts into a wall of the hole and/or into a region around the hole and/or effects a deformation of the wall of the hole and/or of the region around the hole. An electrical contact can thus be established between the workpiece and the blind rivet element, for example. In addition, the contact section secures the blind rivet element against deformation of the sleeve body at the workpiece. I.e. the blind rivet element can be pre-installed at the workpiece by the contact section.

It is furthermore an object of the invention to provide a method of fastening a blind rivet element by which a reliable mechanical and electrical connection can be established between a workpiece and the blind rivet element.

A method in accordance with the invention which satisfies this object comprises the features of claim 19.

A blind rivet element in accordance with the invention has the advantage that an electrical connection is at least reliably established between the workpiece and the sleeve body by a separately configured contact section of the sleeve body when the blind rivet element is fastened to the workpiece. If the bolt element is electrically conductively connected to the sleeve body, there is also a corresponding electrical connection between the workpiece and the bolt element so that, for example, a line for the electrical grounding of the workpiece can be simply connected to the bolt element. In addition, the contact section acts as a kind of security against loss before the sleeve body is deformed for a final fastening of the blind rivet element to the workpiece.

The contact section is in particular configured such that it is able to cut through a protective layer or a protective coat of the workpiece as part of a fastening of the blind rivet element so that the contact section directly contacts at least an electrically conductive section of the workpiece. The contact section is preferably formed integrally at an outside of the sleeve body. The sleeve body is e.g. at least sectionally configured as a hollow cylinder.

The blind rivet element is preferably introduced with its sleeve body into a hole of the workpiece, which is formed complementary to the sleeve body, for fastening the blind rivet element. The blind rivet element can be prefixed to the workpiece by the introduction of the blind rivet element into the hole. The diameter of the hole and the outer diameter of the sleeve body are preferably match to one another to establish a—possibly additionally—press fit. The sleeve body is preferably sectionally radially outwardly deformed for the actual (final) fastening of the blind rivet element so that a section of the sleeve body which is peripheral as a rule engages behind the workpiece in a form-fitted manner in the region around the hole. This deformation of the sleeve body is effected by an axial movement of the bolt element, for example in that the sleeve body is seated on a shoulder of the bolt element and is compressed in the axial direction.

The hole of the workpiece into which the blind rivet element is introduced is preferably already present. It is, however, also conceivable, that the hole is produced by the blind rivet element, in particular by a punching process (stamping of the blind rivet element).

In accordance with an embodiment, the contact section is set off from the sleeve body. The contact section, for example, has one or more projections which extend from the outer jacket surface of the sleeve body outwardly away from the sleeve body in the radial direction. The wall of the hole is hereby—with a corresponding matching of the outer sleeve body diameter to the diameter of the hole—locally acted on by a comparatively high force per surface as part of the introduction of the sleeve body so that a projection of the contact section locally deforms the workpiece and engages into the workpiece. Such a projection in particular engages through an insulating protective layer of the workpiece and establishes an electrical contact to the workpiece.

In accordance with a further embodiment, the contact section comprises at least one peripheral edge, in particular a thread. The sleeve body can, for example, have a conventional external thread with a pitch (e.g. a right-hand thread). A cutting of the edge into the wall of the workpiece can be facilitated by a peripheral edge which includes an angle between the axial direction of extent of the sleeve body and the direction of extent of the edge. At the same time, the sleeve body can be screwed into the hole and can thus be (pre-)installed at the workpiece.

In accordance with a further embodiment, the contact section comprises at least one rib which extends in the axial direction and/or in the peripheral direction. Such a rib can be provided alternatively or additionally to a thread. The contact section preferably has a sharp edge—independently of whether the contact section has a rib, a peripheral edge or a thread—to ensure a secure electrical contact and/or fixing of the sleeve body to the workpiece.

The sleeve body preferably has a flange section having a contact surface for the workpiece. The flange section is in particular provided to bound a movement of the sleeve body relative to the workpiece in an axial direction, for example when the flange section abuts the workpiece as part of a screwing of the sleeve body into the hole of the workpiece. The contact section of the sleeve body can in particular be provided in the region adjacent to and/or at the contact surface of the flange section. It is therefore also possible to provide contact sections both at the flange section and at an outer jacket surface of the sleeve body to ensure a particularly secure electrical contact of the workpiece.

In accordance with a further embodiment, the bolt element and/or the sleeve body has/have at least one coupling section which at least couples the sleeve body and the bolt element rotationally fixedly with one another. On the one hand, a rotational movement exerted onto the bolt element can hereby be transmitted to the sleeve body, in particular to introduce the sleeve body into the hole, and to fix it to the workpiece. On the other hand, the rotationally fixed coupling can be utilized to suppress a rotation of the bolt element in favor of an axial movement of the bolt element by which the sleeve body is sectionally deformed as part of the final fastening of the blind rivet element.

If the bolt element and the sleeve body are coupled with one another, in addition to the rotationally fixed coupling in the axial direction, the bolt element is advantageously fixed to the sleeve body so that the bolt element does not accidentally release from the sleeve body before or during the installation of the blind rivet element.

The coupling section can comprise a plurality of ribs extending in the axial direction. A rotationally fixed coupling can hereby be implemented between the sleeve body and the bolt element. A respective coupling section can in particular be provided at the sleeve body and at the bolt element, with the coupling sections engaging into one another. In this case, the coupling section of the sleeve body is preferably arranged at the radially inner side.

In accordance with a preferred embodiment, the coupling section is configured such that the sleeve body and the bolt element are coupled to one another up to a reaching of a threshold value of a force acting between the sleeve body and the bolt element. A fastening movement can hereby be transmitted onto the sleeve body for the purpose of fixing the sleeve body to the workpiece for so long until the coupling is released by an exceeding of the threshold value and a further fastening movement can be carried out without also rotating the sleeve body in so doing and/or without axially moving it. The threshold value can in particular relate to a shear force acting between the sleeve body and the bolt element which, on a rotation of the sleeve body and the bolt element, acts between these parts. A release of the rotationally fixed coupling can in particular be desirable when the sleeve body is already fixed to the workpiece and should be deformed by a rotational and axial movement of the bolt element relative to the sleeve body.

In accordance with a further preferred embodiment, the bolt element comprises a thread. An electrical conductor connected to ground can hereby, for example, be connected to the bolt element or to the blind rivet element by a screw connection.

The blind rivet element can comprise a fastening element associated with the bolt element. If the bolt element has a thread, the fastening element is in particular configured as a nut which e.g. has a polygonal periphery, in particular a hexagonal periphery, so that the nut can be rotated by means of a standard tool wrench.

In accordance with a preferred embodiment, the blind rivet element comprises a nut which cooperates with the thread of the bolt element and with a flange section of the sleeve body. The nut can in particular be the above-named fastening element associated with the bolt element. The nut is preferably used to fix and to fasten the blind rivet element to the workpiece by a common fastening movement, as will be explained in more detail in the following. A rotation of the nut screwed onto the bolt element in the direction of the flange section can in particular be converted into the already described axial movement of the bolt element by which the sleeve body is shaped for the final fastening of the blind rivet element.

The invention further relates to a component assembly comprising a workpiece and a blind rivet element, in particular in accordance with at least one of the above-described embodiments, wherein the blind groove element comprises a sleeve body and a bolt element led through the sleeve body. The blind rivet element is introduced into a hole of the workpiece and is fastened to the workpiece, in particular by a form-fit of the sleeve body. At least one contact section of the sleeve body engages into a wall of the hole and/or into a region around the hole so that a reliable mechanical contact and/or electrical contact is/are established between the workpiece and the blind rivet element.

The invention further relates, as initially mentioned, to a method of fastening a blind rivet element to a workpiece which has a hole which is in particular preshaped, wherein the blind rivet element is in particular configured in accordance with at least one of the above-described embodiments. The blind rivet element comprises at least one sleeve body and a bolt element led through the sleeve body. The method comprises the blind rivet element being introduced into the hole of the workpiece and the sleeve body being sectionally deformed by an axial movement of the bolt element relative to the sleeve body to fasten the blond rivet element to the workpiece. As part of the introduction of the blind rivet element and/or as part of the fastening process, at least one contact section of the sleeve body is brought into engagement with a wall of the hole and/or with a region around the hole to establish a mechanical contact and/or an electrical contact between the workpiece and the blind rivet element.

In accordance with an embodiment, the sleeve body is introduced into the hole of the workpiece by a first rotational and/or axial movement, with the contact section cutting into the wall of the hole and/or into the region around the hole and/or deforming the wall of the hole and/or the region around the hole in a first installation step by the first rotational and/or axial movement to establish a mechanical contact and/or an electrical contact between the workpiece and the blind rivet element. The bolt element and the sleeve body can be rotationally fixedly coupled to one another during the first installation step.

In accordance with a further embodiment, the sleeve body is deformed and is thereby fastened to the workpiece in a second installation step by a second rotational and/or axial movement, in particular with the sleeve body being substantially at rest during the second installation step.

The second installation step in particular comprises an axial movement of the bolt element relative to the sleeve body which is effected by a rotational movement of the bolt element and/or which is effected by a nut associated with the bolt element. In this respect, the nut cooperates with a flange section of the sleeve body whose contact surface contacts the workpiece in a region around the hole.

In accordance with a preferred embodiment, rotational movements having the same rotational direction are carried out in the first installation step and in the second installation step. The rotational direction of a first rotational movement of the sleeve body and/or of a nut associated with the bolt element is in particular identical to the rotational direction of a second rotational movement of the nut. The blind rivet element can hereby be particularly easily fastened to the workpiece. For example, the first and second installation steps are effected in that the nut is rotated by a tool engaging at said nut. The screwing of the sleeve body is first effected until the latter abuts axially. A further rotational movement of the nut in the same rotational sense then results in an axial travel of the bolt element and thus in the deformation of the sleeve body.

The invention will be explained only by way of example with reference to an advantageous embodiment and to the enclosed drawings. There are shown:

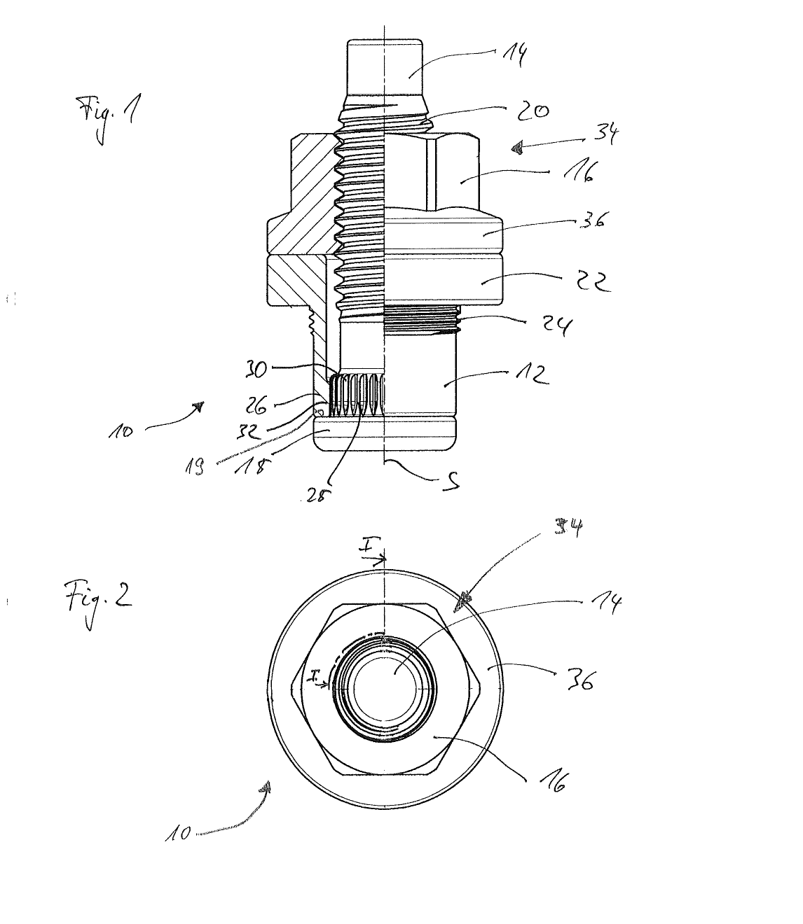

FIG. 1 an embodiment of the blind rivet element in accordance with the invention;

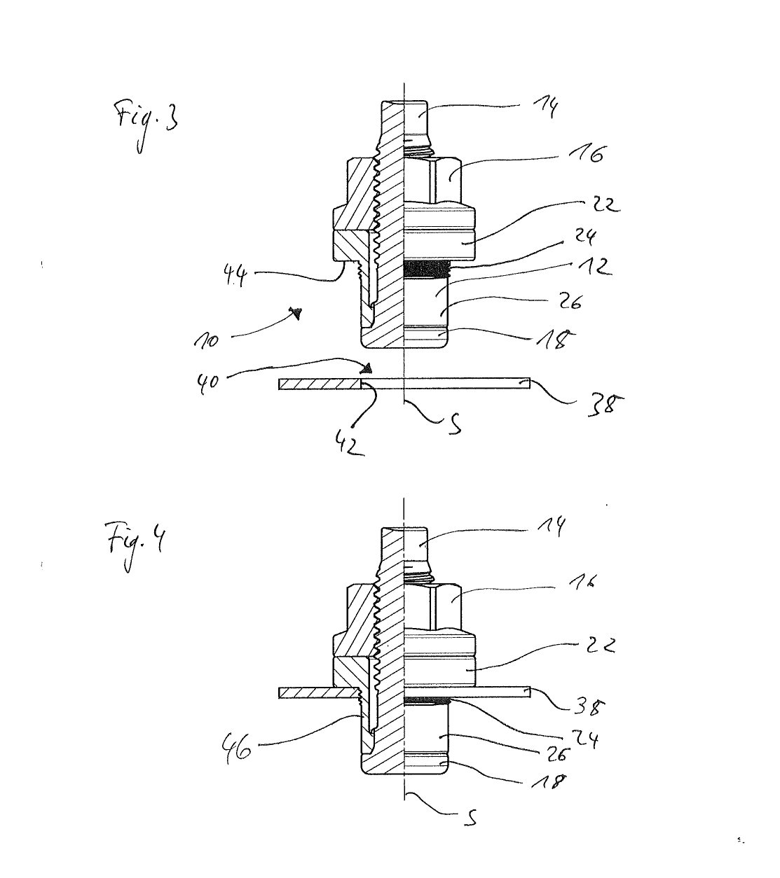

FIG. 2 a plan view of the blind rivet element of FIG. 1; and

FIGS. 3 to 5 an embodiment of the method in accordance with the invention for fastening the blind rivet element of FIGS. 1 to 2 to a sheet metal part.

FIG. 1 shows a rotationally symmetrically configured blind rivet element 10 which comprises a sleeve body 12, a bolt element 14 led through the sleeve body 12 as well as a nut 16. The bolt element 14 has a bolt head 18 on whose shoulder 19 the sleeve body 12 is seated. The bolt element 14 furthermore has a thread 20 which cooperates with an internal thread of the nut 16, i.e. the nut 16 is screwed onto the bolt element 14 in the region of the thread 20.

The view of FIG. 1 is divided with respect to an axis of symmetry S into a left-hand sectional view and into a right-hand side view. The sectional plane I with respect to the left-hand sectional view in entered in FIG. 2. It must be noted in this respect that the sectional plane I extends sectionally linearly through the sleeve body 12 and the nut 16. The sectional plane I furthermore extends in a curved manner along the outer periphery of the bolt element 14 so that the bolt element 14 is effectively shown in a side view in the left-hand sectional view of FIG. 1.

The blind rivet element of FIG. 1 will be explained in more detail in the following.

The sleeve body 12 is hollow cylindrical and has a radially outwardly facing flange section 22. A peripheral, self-tapping thread 24 is provided beneath the flange section 22 at the sleeve body 12 and acts as a contact section of the blind rivet element 10. The sleeve body 12 cooperates at an end 26 remote from the flange section 22 with the bolt element 14, with a rotationally fixed coupling being established between the sleeve body 12 and the bolt element 14 in this region. For this purpose, the bolt element 14 has a coupling section 28 which is formed peripherally by a plurality of ribs 30 extending in the axial direction. The ribs 30 are uniformly spaced apart from one another along the periphery of the bolt element 14. The sleeve body 12 has a peripheral coupling section 32 at the inner side at the end 26; it is configured in rib-like form analog to the coupling section 28, with the respective ribs of the coupling section 32 each engaging between the ribs 30 of the coupling section 28 (and vice versa). The sleeve body 12 can additionally be pressed toward the coupling section 28 of the bolt element 14 in the region of the end 26 so that a corresponding axial coupling is also present between the bolt element 14 and the sleeve body 12. The end 26 and the shoulder 19 additionally provide a coupling of the components 12, 14 in the axial direction.

The nut 16 is configured as a commercial nut which has a polygonal section 34 (peripheral contour of a regular hexagon) and a flange section 36 having a circular cross-section (cf. FIGS. 1 and 2).

It will now be described with reference to FIGS. 3 to 5 how the blind rivet element 10 of FIG. 1 is fastened to a sheet metal part 38 by means of the method in accordance with the invention.

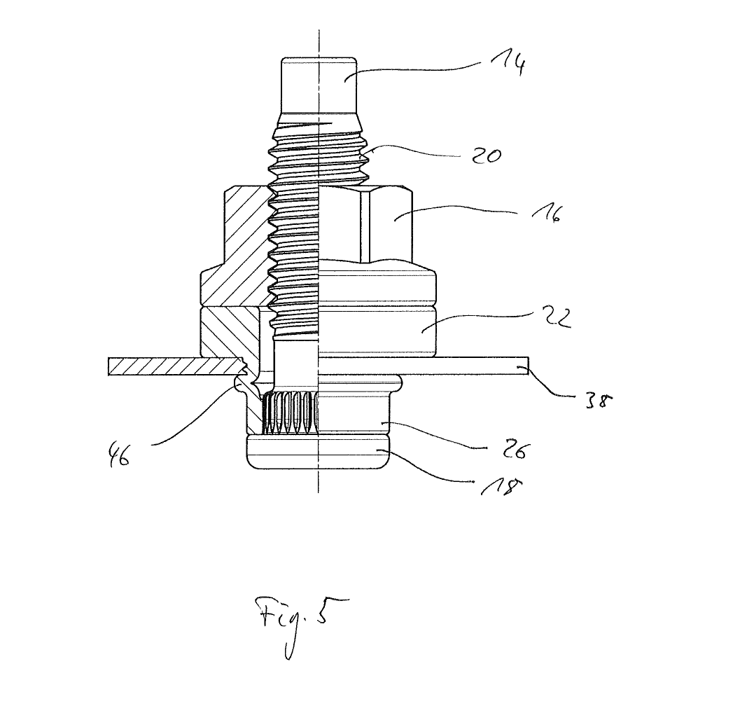

The sheet metal part 38 has a circular hole 40 with respect to the axis of symmetry S and its diameter is adapted such that the blind rivet element 10 can be introduced into the hole 40 (cf. FIG. 3 and FIG. 4). For this purpose, the blind rivet element 10 is led by the bolt head 18 and the end 26 of the sleeve body 12 through the hole 10 until the thread 24 of the sleeve body 12 contacts a wall 42 of the hole 40. The nut 16 is then rotated clockwise with respect to the perspective of FIG. 2 using a tool wrench, not shown.

The nut 16 is generally displaced relative to the bolt element 14 by a rotation clockwise in the axial direction of the bolt head 18 or of the sleeve body 12 (screwing of the nut 16 onto the bolt element 14 into the position shown in FIG. 3). A rotation and an axial displacement of the nut 16 relative to the bolt element 14 effected hereby is naturally only possible, however, when neither an axial movement of the nut 16 nor an axial movement of the bolt element 14 is blocked.

In the present embodiment, a rotation of the nut 16 clockwise as well as an axial movement relative to the bolt element 14 effected hereby is blocked when the nut 16 lies on the flange section 22 of the sleeve body 12 and the sleeve body 12 is seated on the bolt head 18 of the bolt element 14 (FIG. 3). This is due to the fact that, on the one hand, an axial displacement of the nut 16 in the direction of the sleeve body 12 and, on the other hand, an opposed axial displacement of the bolt element 14 in the direction away from the sleeve body 12 (upward in FIG. 3) is in particular directly blocked by the sleeve body 12 in the state shown in FIG. 3. The sleeve body 12 is therefore ultimately clamped between the nut 16 and the bolt head 18. For this reason, the bolt element 14 is also moved in a compulsory manner on a rotation of the nut 16 clockwise from the occurrence of the above-described blocking onward. As part of this rotation, the sleeve body 12 is also in particular also rotated by the mutually engaging coupling sections 28, 32 (FIG. 1). In other words, a corresponding rotation of the total bind rivet element 10 is effected by the rotation of the nut 16.

It becomes clear from the above description that the sleeve body 12 is screwed into the hole 40 by a rotation of the nut 16 clockwise, with the thread 24 cutting into the wall 42 of the hole 40 and establishing a reliable electrical contact between the sheet metal part 38 and the sleeve body 12. At the same time, due to their mechanical contact, the nut 16 and the bolt element 14 are likewise electrically connected to the sleeve body 12 or to the sheet metal part 38 so that a line, not shown, for the electrical grounding of the sheet metal part 38 can be connected to the bolt element 14. The sleeve body 12 is rotated clockwise (by the corresponding rotation of the nut 16) until the flange section 22 of the sleeve body 12 contacts the sheet metal part 38 (FIG. 4) with a contact surface 44 facing the sheet metal part 38. The blind rivet element 10 is now prefixed to the sheet metal part 38.

Starting from the state shown in FIG. 4, the nut 16 is now rotated further clockwise. A further rotation of the sleeve body 12 is now blocked, however, since the flange section 22 of the sleeve body 12 contacts the sheet metal part 38 with the contact surface 44. An axial movement of the bolt element 14 relative to the nut 16 and the sleeve body 12 is now caused by a further rotation of the nut 16, with the bolt head 18 exerting an axial force onto the sleeve body 12. During the further rotation of the nut 16, the bolt element 14 is therefore moved in a compulsory manner upwardly in the axial direction (FIG. 4), whereby the sleeve body 12 is deformed. Specifically, a section 46 of the sleeve body 12 disposed between the end 26 and the thread 24 is radially outwardly deformed so that the section 46 engages behind the sheet metal part 38 in the region around the hole 40 in the sense of a form-fitted rivet connection (FIG. 5). The blind rivet element 10 is now securely fastened to the sheet metal part 38.

During the total rotation of the nut 16—that is during the screwing in of the sleeve body 12 and during the “pulling out” of the bolt element 14—the rotationally fixed coupling remains between the sleeve body 12 and the bolt element 14. There would otherwise be the danger that the bolt element 14 also rotates with the nut 16 and does not move in the desired manner axially away from the sheet metal part 38 to shape the sleeve body 12 as described above.

The pitch of the thread 20 of the bolt element 14 corresponds to a pitch of the internal thread of the nut 16 and is adapted such that the required torque for the rotation of the nut 16 or for the resulting axial movement of the bolt element 14 relative to the nut 16 is below a predefined threshold value. Provision can be made for this purpose that the pitch of the thread 20 should not exceed a predefined value.

Instead of introducing the blind rivet element 10 into the preshaped hole 40 as described, it is also conceivable to stamp the blind rivet element 10 into the sheet metal part 38. The separate production of the hole 40 could then be omitted.

The screwing of the sleeve body 12 into the hole 40 does not necessarily have to be carried out indirectly by the rotation of the nut 16. It is rather also possible to rotate the sleeve body 12 directly itself, for example using pliers which engage at the flange section 22 of the sleeve body 12 and is correspondingly rotated for screwing in the sleeve body 12.

It is equally understood that the bolt element 14 does not necessarily have to be pulled out by rotating the nut 16. It is thus conceivable to engage directly at the bolt element 14 by means of suitable tools, e.g. a lever, to move it axially. It would alternatively also be possible to use a tool with which the bolt element 14 is rotated counter-clockwise and the nut 16 is simultaneously held in a rest position. During the shaping of the sleeve body 12, the coupling between the sleeve body 12 and the bolt element 14 is released in this respect so that the bolt element 14 is “unscrewed” from the sheet metal part 38 and is moved in the axial direction relative to the sleeve body 12.

### REFERENCE NUMERAL LIST

10 blind rivet element

12 sleeve body

14 bolt element

16 nut

18 bolt head

20 thread

22 flange section

24 thread

26 end

28 coupling section

30 rib

32 coupling section

34 polygonal section

36 flange section

38 sheet metal part

40 hole

42 wall

44 contact surface

46 section

S axis

I sectional plane

1. A blind rivet element for fastening to a workpiece, the workpiece having a hole, the blind rivet element comprising a sleeve body and a bolt element led through the sleeve body;
wherein the blind rivet element is configured to be introduced into the hole of the workpiece and the sleeve body is configured to be sectionally deformed by an axial movement of the bolt element relative to the sleeve body to fasten the blind rivet element to the workpiece; and
wherein the sleeve body has at least one contact section which is arranged and configured such that the at least one contact section cuts into at least one of a wall of the hole and a region around the hole and/or such that the at least one contact section effects a deformation of at least one of the wall of the hole and of the region around the hole.

2. The blind rivet element in accordance with claim 1, wherein the at least one contact section is arranged and configured to establish an electrical contact between the workpiece and the blind rivet element.

3. The blind rivet element in accordance with claim 1, wherein the at least one contact section is set off from the sleeve body.

4. The blind rivet element in accordance with claim 1,
wherein the at least one contact section comprises at least one peripheral edge.

5. The blind rivet element in accordance with claim 1,
wherein the at least one contact section comprises at least one rib which extends in at least one of an axial and a peripheral direction.

6. The blind rivet element in accordance with claim 1,
wherein the sleeve body has a flange section having a contact surface for the workpiece.

7. The blind rivet element in accordance with claim 1,
wherein at least one of the bolt element and the sleeve body has at least one coupling section which couples the sleeve body and the bolt element to one another, at least in a rotationally fixed manner.

8. The blind rivet element in accordance with claim 7,
wherein the at least one the coupling section comprises a plurality of ribs extending in an axial direction.

9. The blind rivet element in accordance with claim 7,
wherein the at least one coupling section is configured such that the sleeve body and the bolt element are coupled to one another up to a reaching of a threshold value of a force acting between the sleeve body and the bolt element.

10. The blind rivet element in accordance with claim 1,
wherein the bolt element comprises a thread.

11. The blind rivet element in accordance with claim 1,
wherein the blind rivet element comprises a fastening element associated with the bolt element.

12. The blind rivet element in accordance with claim 10,
wherein the blind rivet element comprises a nut which cooperates with the thread of the bolt element and with a flange section of the sleeve body.

13. The blind rivet element in accordance with claim 11,
wherein the bolt element comprises a thread and wherein the blind rivet element comprises a nut which cooperates with a thread of the bolt element and with a flange section of the sleeve body.

14. The blind rivet element in accordance with claim 12, wherein the nut cooperates with the thread of the bolt element and with the flange section of the sleeve body to move the bolt element in the axial direction.

15. A component assembly comprising a workpiece and a blind rivet element, wherein the blind rivet element comprises a sleeve body and a bolt element led through the sleeve body;
wherein the blind rivet element is introduced into a hole of the workpiece;
wherein the blind rivet element is fastened to the workpiece;
and wherein at least one contact section of the sleeve body engages and/or taps into a wall of the hole and/or into a region around the hole.

16. The component assembly in accordance with claim 15, wherein the at least one contact section of the sleeve body engages and/or taps into the wall of the hole and/or into the region around the hole, so that an electrical contact is established between the workpiece and the blind rivet element.

17. The component assembly in accordance with claim 15, wherein the blind rivet element is fastened to the workpiece by a form fit of the sleeve body.

18. A method of fastening a blind rivet element to a workpiece which has a hole,
wherein the blind rivet element comprises a sleeve body and a bolt element led through the sleeve body, the method comprising the steps of:
introducing the blind rivet element into the hole of the workpiece,
sectionally deforming the sleeve body by an axial movement of the bolt element relative to the sleeve body to fasten the blind rivet element to the workpiece; and
wherein, as part of the step of introducing the blind rivet element and/or as part of the fastening procedure, at least one contact section of the sleeve body is brought into engagement with a wall of the hole and/or with a region around the hole.

19. The method in accordance with claim 18, wherein the at least one contact section of the sleeve body is brought into engagement with the wall of the hole and/or with the region around the hole in order to establish an electrical contact between the workpiece and the blind rivet element.

20. The method in accordance with claim 18,
wherein the sleeve body is introduced into the hole of the workpiece by a first rotational and/or axial movement,
with the at least one contact section cutting into the wall of the hole and/or into the region around the hole and/or deforming the wall of the hole and/or the region around the hole in a first installation step by the first rotational and/or axial movement.

21. The method in accordance with claim 20,
wherein the bolt element and the sleeve body are rotationally fixedly connected to one another during the first installation step.

22. The method in accordance with claim 18,
wherein the sleeve body is deformed and is thereby fastened to the workpiece in a second installation step by a second rotational and/or axial movement.

23. The method in accordance with claim 18,
wherein the second installation step comprises an axial movement of the bolt element relative to the sleeve body which is effected by a rotational movement of the bolt element and/or which is effected by the nut associated with the bolt element, with the nut cooperating with a flange section of the sleeve body which contacts the workpiece at a contact surface in a region around the hole.

24. The method in accordance with claim 18,
wherein rotational movements having the same direction of rotation are carried out in the first installation step and in the second installation step.

25. The method in accordance with claim 24,
wherein a first rotational movement of the sleeve body and/or of a nut associated with the bolt element and
a second rotational movement of the nut being carried out in the same direction of rotation.
